(19) United States
(12) Patent Application Publication
(10) Pub. No.: US 2003/0061207 A1
(43) Pub. Date: Mar. 27, 2003

(54) Query filter for querying a multitude of databases

(76) Inventor: Leonid Spektor, Toronto (CA)

Correspondence Address: DENNISON ASSOCIATES, 133 RICHMOND STREET WEST, SUITE 301, TORONTO, ON, M5H 2L7, CA

(21) Appl. No.: 10/005,598

(22) Filed: Dec. 7, 2001

Related U.S. Application Data
(60) Provisional application No. 60/274,053, filed on Mar. 7, 2001.

(51) Int. Cl. G06F 17/30; G06F 7/00

(52) U.S. Cl. 707/3

(57) ABSTRACT

A method, system and apparatus for executing SQL-like query selections on the structured and semi-structured data files, independent of the files formats or files location. A method, system and apparatus for expanding the embraced SQL SELECT grammar with the user-supplied ordinary and group plug-ins functions.

### FIELD OF THE INVENTION

The present invention is directed to a method, system and apparatus for executing SQL-like query selections on structured and semi-structured data files, independent of the file formats or file locations. In particular, the present invention provides a method, system and apparatus for expanding the embraced SQL SELECT grammar with user-supplied ordinary and group plug-ins functions.

### BACKGROUND OF THE INVENTION

With the amounts of available information doubling nearly every twenty years, seventy percent of information, according to the latest estimates, remains inaccessible or inactive, due to obsolescence or the fast pace of change.

To circumvent this crisis, people in the information-processing field more than ever need coherent, adaptable data querying and reporting tools that provide analogous interface, regardless of the data source or data representation.

Structured Query Language (SQL) has emerged as one of the most prevalent data query and reporting tool that navigates relational database-management systems (RDBMS).

Following SQL industry and academia acceptance, numerous versions of commercially available SQL-alike dialects, tailored, for specialized non-RDBMS needs, have appeared on the market. Just to name a few, these include SQL-based systems for viewing object-oriented or spatial information, for data mining, or for querying the web pages containing Extended Markup Language (XML) declarations.

To suit its needs, an enterprise may store its data in variety of mediums: flat text files, web pages, relational, network, and/or object-oriented databases, data warehouses, or all of the above (just to name a few).

If the available data model does not fall into the category for which an SQL-based dialect is commercially available, or, even worse, the enterprise data model encompasses a variety of representations and formats, the company is forced to develop expensive customized applications to realize its basic querying or reporting needs. To make things even more complicated, many of these applications are developed with the help of several programming languages, oftentimes simply because one programming language lacks a simple feature, like the flow of control mechanism that is absent in basic SQL.

It would be much simpler if one SQL-alike dialect could accommodate all kinds of data, be such data structured or semi-structured in its nature, especially data that comes from virtual databases scattered throughout the cyberspace.

Many more elegant solutions can be achieved with expandable SQL-alike select grammar alone, if a user could only augment basic SQL grammar with new language dictions performing special tasks that are absent or difficult to achieve with the means of the basic SQL alone.

### SUMMARY OF THE INVENTION

In attempt to disassociate SQL-alike interface from any potential data source or data format, and to provide a mechanism to expand the SQL select grammar with new dictions that suit unique business needs or otherwise difficult to achieve with basic SQL grammar—Query Filter was contrived as a universal and expandable tool for data querying and reporting.

The foremost idea behind the Query Filter is to provide an SQL-based dialect that works with any data source and data format, providing that data source and data format are represented by an external computer program that supplies upon request one or more rows of data in a readable tabular format.

The second idea behind the Query Filter is to provide a flexible mechanism, called the plug-ins, to expand the SQL select grammar with the new dictions. The plug-ins are user-written, preferably C programming language subroutines with the purpose of extending the capabilities of a basic SQL language, aimed at performing special tasks that are absent or difficult to achieve with the means of the basic SQL alone.

It is not intended that the method, system and apparatus for providing the Query Filter be summarized here in its entirety. Rather, further features, aspects and advantages of the Query Filter are set forth in or are apparent from the following drawings, detailed description and claims that follow.

### BRIEF DESCRIPTION OF THE DRAWINGS

Referring now to the drawings in which like reference numbers represent corresponding parts throughout:

FIG. 1 presents a schematic of the Query Filter architecture.

### DETAILED DESCRIPTION OF THE PREFERRED EMBODIMENTS

It will be understood that the foregoing brief description and the following detailed description are exemplary and explanatory of the method, system and apparatus for providing the Query Filter, but are not intended to be restrictive thereof or limiting of the advantages which can be achieved by the Query Filter. Thus, the accompanying drawings referred to herein and constituting a part hereof, illustrate embodiments of the Query Filter and, together with the detailed description, serve to explain the principles of the Query Filter.

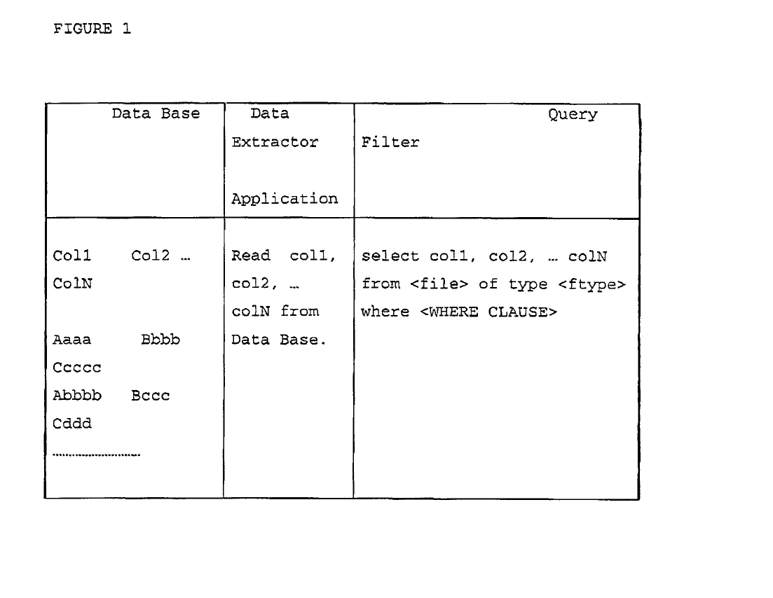

The Query Filter architecture involves three interconnected components: (a) The Query Filter, (b) The Data Extractor Application, and (c) The Database. See FIG. 1 for a schematic of the Query Filter architecture.

The Query Filter is an SQL-like dialect for issuing and parsing relational queries.

The Data Extractor Application is a computer program that extracts the data or obtains information about the supported Database schema, and returns the database schema or the given columns of data as one row of text

The Database is a local or distributed collection of structured or semi-structured data files.

The interconnection of the components may be accomplished by many means depending on the operating system of the computers running the databases and Query Filter. For example, for UNIX and UNIX-like operating systems such as LINUX, as shown in the attached Figures, the interconnection may be achieved by a UNIX pipe. For other operating systems such as WINDOWS, similar means for interconnection are available.

The Query Filter working sessions that executes a typical SELECT statement will now be described. First, the user issues a SELECT query to the Query Filter. The Query Filter examines its operating system environment, parses the supplied SQL select dictions, and issues a call via the interconnection such as a UNIX read pipe to the external program, called the Data Extractor Application, to list its Database schema.

The Data Extractor Application parses its input arguments, obtains information about the supported Database schema, and writes the requested information to the standard output.

The Query Filter reads the Data Extractor Application reply via the UNIX read pipe interconnection and validates the requested columns compliance with the supported Database schema.

If the request is unsupported by the Database schema, the Query Filter terminates with a suitable error message.

If the request is supported by the Database schema, the Query Filter issues a call (via the UNIX read pipe) to the Data Extractor Application to return the given columns of data as one row of text.

The Data Extractor Application parses its input arguments, obtains the requested columns of data from its Database, and returns the rows of extracted data as text by writing it to the standard output.

The Query Filter reads the rows of data from the UNIX read pipe. The filtering, specified in the WHERE language clause is applied against the intended data columns. The rows of data that pass the filtering selection only are written to the standard output, for the user interpretation.

The Query Filter is a computer program that generates the requested SQL SELECT reports over the columns of data supplied by the Data Extractor Application.

The Query Filter communicates with the Data Extractor Application via a UNIX pipe mechanism by reading standard input from the UNIX pipe, or writing standard output to the UNIX pipe.

The Query Filter learns about the location of the Data Extractor Application via designated variable that is set within the user UNIX environment as follows.

The Query Filter “<select clause>” grammar follows, with a few exceptions, a basic syntax of SELECT statement present in all popular SQL dialects.

The supported Query Filter grammar in Backus Naur Form is as follows:

SELECT [DISTINCT] column function | expr {, column | function | exr} FROM filename [file_alias] OF TYPE filetype [, filename file_alias OF TYPE filetype] [WHERE search_condition] [ORDER BY [ASCENDING|DESCENDING] column | function {, column | function }] [GROUP BY column {, column} [HAVING search_cond]]

Where:

column—name of the data column, supported by the data extractor application. To avoid ambiguities, name of the column may not be ‘*’, since data extractor application is allowed to support heterogeneous records present in one source data file.

function—a built-in aggregate, mathematical, string, or time-handling function that operates on column's or stipulated values:

TABLE 1

| Function | Dscription |
|---|---|
| SUM (c) | Computes the sum of column c |
| | numerical entries. |
| AVG (c) | Computes the average of column |
| | c numerical entries. |
| COUNT (c) | Computes the number of column |
| MIN (c) | c entries. |
| | Computes the minimum value of |
| | column c textual entries. |
| NMIN (c) | Computes the minimum value of |
| | column c numerical entries. |
| MAX (c) | Computes the maximum value of |
| | column c textual entries. |
| NMAX (c) | Computes the maximum value of |
| | column c numerical entries. |
| SQRT (x) | Computes the square root of x. |
| LOG10 (x) | Computes the base-10 logarithm |
| | of x. |
| LOG (x) | Computes the natural logarithm |
| | of x. |
| EXP (x) | Computes the exponential |
| | function e**x. |
| POW (x, y) | Computes x raised to the power |
| | of y, x**y. |
| ABS (x) | Returns the absolute value of |
| | its int operand x. |
| SIN (x) | Return trigonometric function, |
| | sin (), of radian argument x. |
| COS (x) | Return trigonometric function, |
| | cos (), of radian argument x. |
| TAN (x, y) | Return trigonometric function, |
| | tan (), of radian arguments x |
| | and y. |
| ASIN (x) | Returns the arc sine of x in |
| | the range −n/2 to n/2. |
| ACOS (x) | Returns the arc cosine of x in |
| | the range 0 to n. |
| ATAN (x) | Returns the arc tangent of x |
| | in the range −n/2 to n/2. |
| ATAN2 (y, x) | Convert rectangular |
| | coordinates (x, y) to polar |
| | (r, 0); atan2 (y, x) computes 0, |
| | the argument or phase, by |
| | computing an arc tangent of |
| | y/x in the range −n to n. |
| CEIL (x) | Returns the least integral |
| | value greater than or equal to |
| | x. |
| FLOOR (x) | Returns the greatest integral |
| | value less than or equal to x. |
| RINT (x) | Rounds x to an integral value |
| | according to the current |
| | IEEE754 rounding direction. |
| STRLEN (s) | Computes the length of the |
| | textual string ‘s’ or column's |
| | s textual value. |
| REPLACE (c, ‘target_string, | Replaces all occurrences of |
| ‘replacement_string’) | the ‘target_string’ with the |
| | ‘replacement_string’ in the |
| | column c. |
| SUBSTR (c, start_index, | Returns a sub-string from the |
| substr_len) | column c starting at |
| | start_index (1...) of the |
| | maximum length of substr_len. |
| STRCAT (string1, string2) | Catenate string2 to string1. |
| CTIME ([CC]YYMMDD, | Returns time in seconds since |
| HHMMSS) | 00:00:00 UTC, Jan. 1, 1970, |
| | given date [CC]YYMMDD and time |
| | HHMMSS columns or values, like |
| | CTIME (‘19990112’, ‘232215’). |
| PLUGIN2 (func_name, arg2) | User-defined non-aggregate |
| | plug-ins function of 2 |
| | arguments. |
| PLUGIN3 (func_name, arg2, | User-defined non-aggregate |
| arg3) | plug-ins function of 3 |
| | arguments. |
| PLUGIN4 (func_name, arg2, | User-defined non-aggregate |
| arg3, arg4) | plug-ins function of 4 |
| | arguments. |
| PLUGIN5 (func_name, arg2, | User-defined non-aggregate |
| arg3, arg4, arg5) | plug-ins function of 5 |
| | arguments. |
| PLUGIN6 (func_name, arg2, | User-defined non-aggregate |
| arg3, arg4, arg5, arg6) | plug-ins function of 6 |
| | arguments. |
| GRPLUGIN2 (func_name, arg2) | User-defined aggregate plug- |
| | ins function of 2 arguments. |
| GRPLUGIN3 (func_name, arg2, | User-defined aggregate plug- |
| arg3) | ins function of 3 arguments. |
| GRPLUGIN4 (func_name, arg2, | User-defined aggregate plug- |
| arg3, arg4) | ins function of 4 arguments. |
| GRPLUGIN5 (func_name, arg2, | User-defined aggregate plug- |
| arg3, arg4, arg5) | ins function of 5 arguments. |
| GRPLUGIN6 (func_name, arg2, | GRPLUGIN6 (func_name, arg2, |
| arg3, arg4, arg5, arg6) | arg3, arg4, arg5, arg6) |
| GRPLUGIN9 (func_name, arg2, | User-defined aggregate plug- |
| arg3, arg4, arg5, arg6, | ins function of 9 arguments. |
| arg7, arg8, arg9) | |

Search_condition—contains separate comparisons for strings and numbers. By default all values are textual strings. Using a numerical, borrowed from the FORTRAN language, comparison or a function enforces data conversion to the appropriate numeric type.

HAVING search_condition—Follows the GROUP BY clause and can contain the same kind of search condition you may specify in a WHERE clause.

TABLE 2

| Comparison | Description |
|---|---|
| = | Textual equal. |
| == | Textual equal. |
| != | Not equal. |
| >= | Textual greater or equal. |
| NGE | Numerical greater or equal. |
| <= | Textual less or equal. |
| NLE | Numerical less or equal. |
| > | Textual greater than. |
| NGT | Numerical greater than. |
| < | Textual less than. |
| NLT | Numerical less than. |
| LIKE ‘string%’ \| LIKE % | Returns true if matching |
| | string is found, false |
| | otherwise. |
| AND | AND clause. |
| OR | OR clause. |
| XOR | Exclusive OR clause. |
| NOT | Not clause. |

expressions—may contain functions and math statements involving operators applied on integer and real numbers:

TABLE 3

| Operator | Description |
|---|---|
| + | Addition. |
| − | Subtraction. |
| / | Division. |
| * | Multiplication. |
| & | Binary AND. |
| \| | Binary OR. |
| % | Mudule operator, |
| | a % b. Divides |
| | two numbers and |
| | returns only the |
| | remainder. |

Query Filter Environment requires setting of the following variable:

A) Mandatory environment variable, QUERY_FILTER_DATA_EXTRACTOR, must point to the location of the data extractor application. For example, a csh user can set Query Filter environment by typing the following command (beware, that in each case the name of the individual data extractor application will differ):

setenv QUERY_FILTER_DATA_EXTRACTOR ˜/bin/my_data_extractor

The data extractor application is a user-written stand-alone application that knows only about the Database (source data file(s)) schema and how to read the columns of data from the stipulated source file of the given type. The user of the Query Filter is responsible for developing or acquiring a data extractor application suitable for his or her data organization. The data extractor application interface protocol is straightforward and presented in the sections below.

B) Optional environment variable, QUERY_FILTER_DATA_EXTRACTOR_CACHE, must point to the directory to be used for intermediate storage of results. Usage of this environment variable is not mandatory but strongly recommended for faster processing when files aliases are used.

C) Optional environment variable, QUERY_FILTER_OUTPUT_FILE, must point to a valid file location path. This variable may be used for sending output to the file directly, in addition to stdout.

The Data Extractor Application is an external computer program supplied by the user with the purpose to provide information to the Query Filter about the Database schema, and to return the requested columns of data as a rows of text.

The Data Extractor Application may be written in any practical programming language of choice and must adhere to two types of the interface protocols.

The Data Extractor Application must adhere to two types of interface protocols:

The first type of interface protocol deals with acquiring tabulated data from the database.

The following synopsis must be observed:

my_data_extractor <MY FILE NAME> <MY FILE TYPE> filed1:field2: . . . [field1: . . . fieldN] “,”

Where:

<MY FILE NAME>— Full path of your data file; <MY FILE TYPE>— Name of my file data type;

field1:field2: . . . [field1: . . . fieldN] — Column, :, separated list of asked columns,

with the same column may be asked more than once;

“,” —Fields separator.

Tabulated output (no blanks within columns) is directed to stdout, with comma acting as a fields separator.

The second type of the interface protocol deals with discovering a database schema.

The following synopsis must be observed:

my_data_extractor <MY FILE NAME> <MY FILE TYPE>—-help

Record <MY RECORD NAME ONE>

(field1:field2: . . . . fieldn)

Record <MY RECORL NAME TWO> (field1:field2: . . . fieldN)

. . .

Record <MY RECORD NAME N> (field1:field2: . . . .fieldN)

Here, braces that encompass column-separated fields names must follow each record name.

The following example is a case in point of a simple Database and its Data Extractor Application.

The Database (a flat file) Company_Widget_Price contains Company, Widget and Price columns as seen below:

| | | |
|---|---|---|
| Company C. | Widget_C | 300.0 |
| Company A. | Widget_A | 100.0 |
| Company B. | Widget_B | 200.0 |
| The Company | Widget_T | 500.0 |

The Data Extractor Application that reads this Database or provides information on its schema may be realized in ksh as follows:

TABLE 4

#?/bin/ksh
##
# Extract designated fields from the file's records.
#
# Synopsys:
#
# data_extractor.ksh <file_name> <file_type>
field1:field2: . . . fieldN “,”
#
# data_extractor.ksh <file_name> <file_type> −help
#
##
export file_name=“$1”
export file_type=“$2”
export fields=“$3”
export separ=“$4”
if [ “$separ” == “” ]
then
export separ=“,”
fi
##
# Output a usage message.
##
function usage_message
{
echo “\nUsage is:\n”
echo “data_extractor.ksh <file_name> <file_type>
field1;field2: . . . fieldN \”, \“\n”
echo “data_extractor.ksh <file_name> <file_type>−help\n”
}
if [ “$file_type” == “Company_Widget_Price” ]
then
##
# Provide a help only.
##
if [ “$fields” == “−help” ]
then
echo “Record (Company:Widget:Price)”
exit 0
fi
if [ “$fields” == “” ] ||[ “$separ” == “” ]
then
usage_message
exit 1
fi
##
# Insert a blank instead of a “:” fields separator.
##
export Fields=‘echo $fields | tr ‘:’ ‘’
##
# Read a record and output selected fields only, separated
by delimiter.
##
while read line
do
if [ “$line” == “” ]
then
continue
fi
unset Arrival
set +A Arrival $line
##
# Concatenate with, _,if field, Company, consists from two
words.
##
if [ “${#Arrival[*]}“ == “4” ]
then
export company=${Arrival[0]}“_”${Arrival[1]}
export widget${Arrival[2]}
export price=${Arrival[3]}
else
export company=${Arrival[0]}
export widget=${Arrival[1]}
export price=${Arrival[2]}
fi
##
# Select requsted fields only + separator.
##
export oline=“”
word_separ=“”
for field_name in $Fields
do
if [ “$field_name” == “Company” ]
then
export oline=$oline$word_separ$company
fi
if [ “$field_name” == “Widget” ]
then
export oline=$oline$word_separ$widget
fi
if [ “$field_name” == “Price” ]
then
export oline=$oline$word_separ$price
fi
export word_separ=$separ
done
##
# Output the requested fields separated by delimiter.
##
if [ “$oline” ?= “” ]
then
echo $oline
fi
done <$file_name
else
usage_message
exit 1
fi
exit 0

With Data Extractor Application in place, a typical user session may then proceed as follows:

setenv

QUERY_FILTER_DATA_EXTRACTOR=./data_extractor.ksh ./query_filter “SELECT REPLACE(Company, ‘_’, ‘ ’), Price FROM ./Company_Widget_Price OF TYPE Company_Widget_Price WHERE Price GE 300.01”

| | |
|---|---|
| Company C. | 300.0 |
| The company | 500.0 |

Please, note, the use of the function REPLACE( ). This function accepts a tabulated field value that may contain several words joined by a hyphen inside the Data Extractor Application. For output purposes hyphens are replaced with the blanks.

The Database may comprise a set of data files, relational databases, HTML pages, XML pages, any other known data source or combination of all of the above located locally or dispersed through a cyberspace.

The Database may be well structured or irregular and incomplete, called semi-structured by the research community? Data lacking well defined constrained structure, or data whose structure may change rapidly and unpredictably (like a WEB page with XML declarations).

The Query Filter in addition to the embraced SQL SELECT grammar supports the user-supplied plug-ins functions.

The notion of the plug-ins functions is to offset limitations of the basic SQL SELECT dialect grammar by giving user a choice to write new dictions that are chiefly required by the business function, or that are otherwise difficult to achieve with the basic SQL grammar.

A case in point of employing the user supplied plug-ins function is to support selection of every 2nd row of data. The basic SQL SELECT grammar does not support the notion of the periodic counters. However, by implementing the plug-ins function EVERY_NTH, selection of every 2nd row reduces to a common SELECT statement with the PLUGN3 (EVERY_NTH, 2, Widget) eq 1 statement in its where clause.

This example shows usage of the plug-ins function, EVERY_NTH, to select every second row containing a widget.

The Database (a flat file) Company_Widget_Price contains Company, Widget and Price columns as seen below:

| | | |
|---|---|---|
| Company C. | Widget_C | 300.0 |
| Company A. | Widget_A | 100.0 |
| Company B. | Widget_B | 200.0 |
| The Company | Widget_T | 500.0 |

The following Query Filter statements select every second row from the Database.

setenv QUERY_FILTER_DATA_EXTRACTOR ./data_extractor.kbsh

./query_filter “SELECT REPLACE(Company, ‘_’‘ ’), Widget, Price FROM ./Company_Widget_Price OF TYPE Company_Widget_Price WHERE

PLUGN3(EVERY_NTH, 2, Widget) eq 1”

| | | |
|---|---|---|
| Company A. | Widget_A | 300.0 |
| The company | Widget_T | 500.0 |

The plug-ins functions are the mechanism to expand the SQL finite grammar. To provide the binding, The Query Filter program is supplied with its source code and the makefile, a script that invokes compilation and linkage of the programming language into executable machine instructions. This makes writing plug-ins very easy, while not restricting what they can do.

The Query Filter C-language source code contains non-obfuscated module, called the plugin.c. This module contains a modifiable table of supported plug-ins function names and, associated C-language subroutines that implement and invoke these plug-ins functions.

To implement a new plug-ins function, the user must observe the following three steps inside the plugin.c module: (a) update the table of the supported plug-ins functions with the new plug-ins function name; (b) implement the associated subroutine that executes the plug-ins function logic; (c) code invocation of the plug-ins subroutine from within the appropriate plug-ins invocation subroutine.

The user-supplied plug-ins functions may be of two kinds: ordinary, like SIN(column name) or COS(column name)); or group, that is operating on a set of values, like MINS(column name) or SUM(column name).

The plug-ins invocation subroutines are predefined subroutines inside the plugin.c module with names starting from the PLUGIN1( ), PLUGIN2( ), . . . PLUGIN<N>( ), or GRPLUGIN1( ), GRPLUGIN2( ), GRPLUGIN<N>( ).

The number at the end of the plug-ins invocation subroutine name, like PLUGIN3( ), indicates the maximum number of arguments supplied to this subroutine. Accordingly, invocation of the user-supplied plug-ins subroutine with N arguments must occur from within the plug-ins invocation subroutine that supports the same number of arguments.

The plug-ins invocation subroutines with names starting from the PLUGIN1( ), PLUGIN2( ), . . . PLUGIN<N>( ) are used for invocation of the ordinary user-supplied plug-dins functions that compute the results right away.

The plug-ins invocation subroutines with names starting from the GRPLUGIN1( ), . . . GRPLUGIN<N>( ) are used for invocation of She group user-supplied plug-ins functions that compute results over a set of values. At the end of the data set, the Query Filter automatically invokes the group plug-ins functions with all arguments set to NULL; and this is when the final results should be computed and output.

This example shows implementation and usage of the group plug-ins function, MY_AVERAGE, to compute the average price of the widget.

First step is to implement the new plug-ins function MY_AVERAGE and add it to the plugin.c module. The following code snippet shows all places affected by the introduction of the new plug-ins function inside the plugin.c module.

TABLE 5

```
Char* plugs_ins[] ={
“MY_AVERAGE”,
. . .
NULL,
};
. . .
static char* “MyAverage(char* number);
. . .
char* grplugin2(char* name, char* arg2 /*Plugs-in
invocation subroutine */
{
  . . .
  if (strcmp(name, “MY_AVERAGE”) == 0)
  {
    return (MyAverage (arg2));
  }
  else if (strcmp(name , “. . .  /* Previous plug-
ins invocation */
    . . .
}
. . .
char* MyAverage(char* number)
{
  static long count = 0;
  static long sum = 0;
  static char% result[BUFSIZ];
  result[0] =‘\0’; /* Output result should
contain empty string, unless it is the last call */
  if (number)
  {
    count++;
    sum += atoi(number)
  }
    else
  {
    sprintf(result, “%ld”, sum / count);
  }
  return (result);
}
```

The next step is to recompile and to link the Query Filter, by issuing the make command.

Once make completes successfully the Query Filter is ready for use.

The Database (a flat file) Company_Widget_Price contains Company, Widget and Price columns as seen below:

| | | |
|---|---|---|
| Company C. | Widget_C | 300.0 |
| Company A. | Widget_A | 100.0 |
| Company B. | Widget_B | 200.0 |
| The Company | Widget_T | 500.0 |

The following Query Filter statements compute the average price of the widget from the company Database

setenv QUERY_FILTER_DATA_EXTRACTOR ./data_extractor.ksh

./query_filter “SELECT grplugin2(MY_AVERAGE, Price) FROM ./Company_Widget_Price OF TYPE Company_Widget_Price”

Invocation of the new user-supplied plug-ins subroutine from inside the plug-ins invocation subroutine should not block preceding user-supplied plug-ins subroutines from invocation. For that purpose, the first argument supplied to the plug-ins is reserved for the plug-ins name, like EVERY_NTH or MY_AVERAGE in our examples The name of the plug-ins is used to discriminate which plug-ins subroutine to invoke.

The data types of all the arguments passed to the plug-ins or returned from the plug-ins subroutines should be pointers to characters.

To make the Query Filter available for use, the plugin.c module must be complied and linked with the rest of the Query Filter source code, using the UNIX make utility.

Although illustrative embodiments have been descried herein in details, it should be noted and understood that the descriptions have been provided for purposes of illustration only and that other variations both in form and detail can be made thereupon without departing from the spirit and scope of the method, system and apparatus for providing a Query Filter. The terms and expressions have been used as terms of description and not terms of limitation. There is no limitation to use the terms or expressions to exclude any equivalents of features shown and described or portions thereof, and the Query Filter should be defined with the claims that follow.

What is claimed is:

1. A method that allows SQL-like query selections with user-defined ordinary and group plug-ins functions operating on structured and semi-structured data files; the method comprising:
a) providing three interconnected independent components: a Query Filter, a Data Extractor Application, and a Database; the Query Filter being an SQL-like dialect for issuing and parsing relational queries, the Data Extractor Application being a computer program that extracts the data or obtains information about the supported Database schema, and returns the database schema or the given columns of data as one row of text and the Database being a local or distributed collection of structured or semi-structured data files; and
b) passing requests between the Query Filter and the Data Extractor Application and between the Data Extractor Application and the Database to allow the Query Filter to view the data of the Database matching the SQL-like query selection.

2. A method as claimed in claim 1 wherein the Query Filter passes a request to the Data Extractor Application, to list the Database schema information.

3. A method as claimed in claim 2 wherein the Database schema information is returned from the Data Extractor Application to the Query Filter.

4. A method as claimed in claim 1 wherein the Query Filter passes a request to the Data Extractor Application, to obtain the values of the desired columns from the Database.

5. A method as claimed in claim 4 wherein the Data Extractor Application returns the request to the Query Filter, with the values of the desired columns selected from the Database.

6. A method as claimed in claim 5 wherein the Query Filter and filters the undesirable column values outputting the intended column values only.

7. A method as claimed in claim 1, wherein the Data Extractor Application supports two types of interface protocols: a first protocol to return information about the Database schema, and a second protocol to return contents of the desired Database columns.

8. A method as claimed in claim 1 wherein the Query Filter possesses En SQL-like grammar defined via Backus Naur Form.

9. A method as claimed in claim 1, wherein the Query Filter learns via a UNIX environment variable about the location of the Data Extractor Application.

10. A method as claimed in claim 1, wherein for the Data Extractor Application to be implemented in any practical programming language of choice.

11. A method as claimed in claim 1, wherein the Query Filter grammar is expanded with user-defined ordinary and group plug-ins functions.

12. A method as claimed in claim 11 wherein the ordinary and group user-defined plug-ins functions are defined by N arguments in the module plugin.c.

13. A method as claimed in claim 12 wherein last call support with all null arguments to the user-defined group plug-ins functions in the module plugin.c, to warrant computation of the final result is provided.

14. A method as claimed in claim 12 wherein data types of all the arguments passed to the plug-ins or values returned from the plug-ins subroutines are pointers to characters.

15. A method as claimed in claim 11 wherein the plugin.c module is computed with user-defined ordinary and group plug-ins functions, and linked it with the Query Filter using the make utility.

16. A method as claimed in claim 1 wherein the Database comprises one or more of local or dispersed throughout a cyberspace structured or semi-structured data files.
